(19) United States
(12) Patent Application Publication
(10) Pub. No.: US 2018/0148572 A1
(43) Pub. Date: May 31, 2018

(54) METHOD FOR THE THERMAL TREATMENT OF POLY-ARYLENE ETHER KETONE KETONE POWDERS SUITABLE FOR LASER SINTERING

(71) Applicant: ARKEMA FRANCE, Colombes (FR)

(72) Inventors: Nadine Decraemer, Beaumontel (FR); Denis Huze, Fontaine Sous Jouy (FR); Hervé Ster, Serquigny (FR); Jerome Pascal, Grandchain (FR); Benoît Brule, Beaumont-le-roger (FR)

(73) Assignee: ARKEMA FRANCE, Colombes (FR)

(21) Appl. No.: 15/830,100

(22) Filed: Dec. 4, 2017

Related U.S. Application Data
(63) Continuation of application No. 14/894,825, filed on Nov. 30, 2015, now abandoned.

(30) Foreign Application Priority Data
May 30, 2013 (FR) 13.54917

(51) Int. Cl. C08L 61/16

(52) U.S. Cl. CPC C08L 61/16; C08G 2650/40; B29K 2071/00; C08J 2371/10

(57) ABSTRACT

The invention relates to a process for the heat treatment of poly(arylene ether ketone ketone) powder suitable for laser sintering, and also to the powders resulting from this process.

### CROSS-REFERENCE TO RELATED APPLICATIONS

This application is a continuation of U.S. application Ser. No. 14/894,825, filed Nov. 30, 2015, which is the national phase of International Application No. PCT/FR2014/051242, filed May 27, 2014, which claims priority from French Application No. 1354917, filed May 30, 2013. The entire disclosures of each of these applications are incorporated herein by reference for all purposes.

### FIELD OF THE INVENTION

The present invention relates to a rapid process for the heat treatment of poly(arylene ether ketone ketone) powder suitable for laser sintering, and also to the powders resulting from this process.

Poly(arylene ether ketone)s and more particularly poly(ether ketone ketone)s (PEKK) are high performance materials. They are used for applications which are restricting in temperature and/or in mechanical stresses, indeed even chemical stresses. These polymers are encountered in fields as varied as aeronautics, offshore drilling or medical implants. They can be employed by molding, extrusion, compression, spinning or also laser sintering in particular. However, their use in this final process requires conditions for the preparation of the powder providing a good flowability in times which are prohibitive industrially.

The technology for the sintering of powders under a laser beam is used to manufacture three-dimensional objects, such as prototypes or models but also functional parts, in particular in the motor vehicle, nautical, aeronautical, aerospace, medical (prostheses, auditory systems, cell tissues, and the like), textile, clothing, fashion, decorative, electronic casing, telephony, home automation, computing or lighting fields.

A fine layer of powder is deposited on a horizontal plate maintained in a chamber heated to a certain temperature. The laser contributes the energy necessary to sinter the powder particles at different points of the powder layer according to a geometry corresponding to the object, for example using a computer having, in memory, the shape of the object and reproducing the shape in the form of slices. Subsequently, the horizontal plate is lowered by a value corresponding to the thickness of a powder layer (for example between 0.05 and 2 mm and generally of the order of 0.1 mm), then a new powder layer is deposited and the laser contributes the energy necessary to sinter the powder particles according to geometry corresponding to this new slice of the object, and so on. The procedure is repeated until the entire object has been manufactured. An object surrounded by non-sintered powder is obtained inside the chamber. The parts which have not been sintered have thus remained in the powder state. After complete cooling, the object is separated from the powder, which can be reused for another operation.

One of the conditions necessary for good operation of the laser sintering process to be obtained consists in using powders exhibiting a good flowability necessary when the powder described above is formed into layers.

Unfortunately, the powders resulting from milling, precipitation or melt atomization processes do not make it possible to obtain powders having good flowability. A long heat treatment has to be applied in order to obtain a powder exhibiting a good flowability.

To date, it has not been possible to obtain a good flowability in an industrially acceptable time, typically well below one hour.

U.S. Pat. No. 7,847,057 relates to a process for the heat treatment of poly(arylene ether ketone) powders, which consists in exposing the powder to a heat treatment of greater than 30 minutes and preferably greater than 1 hour at a temperature greater than 20° C. to the glass transition temperature of the polymer.

This treatment, applied to poly(ether ether ketone)s, makes it possible to obtain powders with a flowability acceptable for the laser sintering process but is very long, which limits the industrial advantage. This heat treatment makes it possible to render the surface of the PEEK powder less rough, which explains their better flowability. A reduction in the treatment time would increase the industrial appeal by increasing the productivity of treatment of the powder.

WO2012047613 also describes a heat treatment applied more particularly to PEKK powders which consists in exposing the powder to a heat treatment of several hours between the transition temperatures of the different crystalline phases, more particularly while approaching the melting point of the polymer corresponding to the crystalline form exhibiting the transition at the highest temperature. The flowability of the powder is found to be improved thereby and the crystallinity resulting from this treatment is retained during the sintering process, conferring certain advantageous physical properties on the sintered object. Here again, the treatment times are relatively long, typically several hours, which is industrially damaging (machine occupation and low productivity).

In order to respond to the requirements to have available powders exhibiting a good flowability, the applicant company has carried out a series of tests demonstrating, contrary to all expectation, that, for certain PEKKs, a much shorter appropriate heat treatment ensures that powders exhibiting the criterion of good flowability are obtained.

### BRIEF SUMMARY OF THE INVENTION

The invention relates to a process for the treatment of powders comprising PEKK, the measured flowability of which exhibits a passage time in a 17 mm funnel of less than 40 s, limit included, preferably of less than 30 s and more preferably of less than 20 s, said flowability being measured in the following way:
A glass funnel with an orifice of 17 mm is filled with the powder up to 5 mm from the edge. The orifice of the bottom is blocked with a finger,
The flow time of the powder is measured with a stopwatch,
If flow does not take place, the funnel is tapped using a spatula. The operation is repeated, if required,
The flow time and the number of tapped blows using the spatula are recorded, comprising the following stages:
Arranging the powder in a ventilated chamber or any other heating system.
Heating the powder at a temperature of between T−10° C. and T+10° C., where T=3.75*A+37.5, expressed in ° C., A representing the percentage by weight of terephthalic unit with respect to the sum of the terephthalic and isophthalic units and is between 55% and 85%, limits included, for a time strictly of less than 30 minutes.

The invention also relates to the powders obtained by such a process and to the objects obtained by the process using such powders.

### DETAILED DESCRIPTION OF THE INVENTION

The poly(arylene ether ketone ketone)s used in the invention comprise units of formula IA, of formula IB and their mixture.

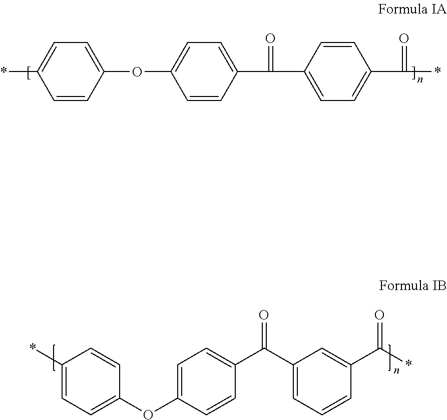

In a more general context, the poly(arylene ether ketone ketone)s corresponding to the generic names PEK, PEEKEK, PEEK or PEKEKK (where E denotes an ether functional group and K a ketone functional group) cannot be excluded, in particular when their use takes place in a way combined with that of the PEKK in proportions where the PEKK represents more than 50% in proportions by weight and preferably more than 80% in proportions by weight, limits included.

Preferably, the poly(arylene ether ketone ketone)s are poly(ether ketone ketone)s comprising a mixture of IA and IB units, so that the percentage by weight of terephthalic units with respect to the sum of the terephthalic and isophthalic units is between 55% and 85% and preferably between 55% and 70%, ideally 60%. Terephthalic and isophthalic unit is understood to mean the formula of terephthalic acid and isophthalic acid respectively.

These poly(arylene ether ketone ketone)s are provided in the form of powders which may have been prepared by milling or precipitation.

They exist, after the heat treatment process of the invention, in the form of a powder, the flowability of which in a 17 mm funnel is less than 40 s, limit included, preferably less than 30 s and more preferably less than 20 s.

The powders or mixtures of powders used in the process which is a subject matter of the invention can be obtained, for example, by a milling process described in the application FR 1160258. They can, if appropriate, be additivated with or contain different compounds, such as reinforcing fillers, in particular inorganic fillers, such as carbon black, nanotubes, which may or may not be of carbon, fibres, which may or may not be ground, stabilizing agents (light, in particular UV, and heat stabilizing agents), glidants, such as silica, or also optical, brighteners, dyes, pigments or a combination of these fillers and/or additives.

The process for the treatment of such powders in accordance with the invention and which makes it possible to obtain the powders in accordance with the invention consists in causing the powder to reside in a device held at temperature, typically between a temperature T−10° C. and T+10° C., where T=3.75*A+37.5, expressed in ° C. (A representing the percentage by weight of terephthalic unit with respect to the sum of the terephthalic and isophthalic units and of between 55% and 85% and preferably between 55% and 70%, ideally 60%), preferably between 1-5° C. and T+5° C. and more preferably between T−3° C. and T+3° C., ideally T, for times which are strictly less than 30 minutes. This is because it has been observed that the optimum temperature depends on the proportion by weight of terephthalic unit with respect to the sum of the terephthalic and isophthalic units according to the linear relationship T=3.75*A+37.5. It would not be departing from the scope of the invention to carry out several successive heat treatments (at the same temperature or at two different temperatures of between T−10° C. and T+10° C., where T=3.75*A+37.5, expressed in ° C., A representing the percentage by weight of terephthalic unit with respect to the sum of the terephthalic and isophthalic units). In a static oven, for example, the treatment time will typically be strictly less than 30 minutes, ideally between 15 and 25 minutes, whereas, in a dynamic heating system, such as a tube in which the powder and a hot gas circulate countercurrentwise or also a heated fluidized bed, a residence time of the order of a few minutes may be sufficient, typically greater than 2 minutes but strictly less than 30 minutes and preferably between 2 and 15 minutes. The treatment can also be carried out in a vane dryer, in a vertical shaft dryer, in a rotary oven or also in a tunnel heated using infrared lamps.

The powder resulting from this heat treatment is subsequently used in a device for sintering powders under a laser beam in order to make possible the manufacture of an object. The use of such powders in processes such as rotational molding cannot be excluded.

### BRIEF DESCRIPTION OF THE DRAWINGS

### EXAMPLES

### Example 1

### Measurement of the Flowability

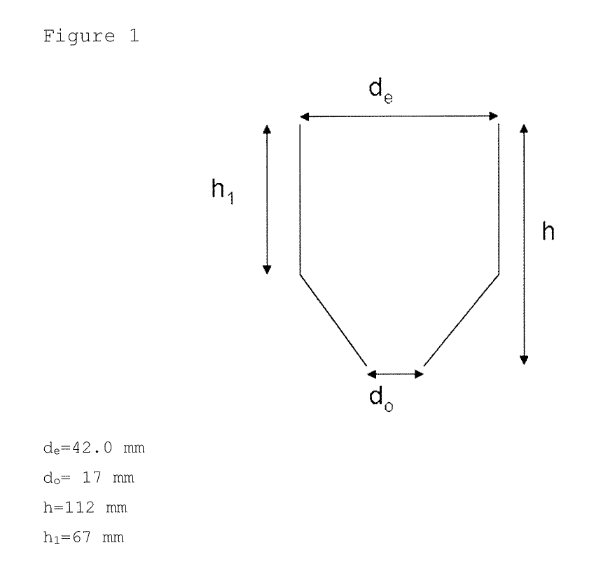

The flowability of these powders was carried out in a glass funnel:
A glass funnel with a 17 mm orifice (FIG. 1) is filled with the powder up to 5 mm from the edge. The orifice of the bottom is blocked with a finger.
The flow time of the powder is measured with a stopwatch.
If flow does not take place, the funnel is tapped using a spatula. The operation is repeated, if required.
The flow time and the number of tapped blows using the spatula are recorded.

### Example 2

A Kepstan® 6003 powder from Arkema, containing 60% of terephthalic units with respect to the sum of the terephthalic and isophthalic units, the particle size of which exhibits a dv50 of 50 μm plus or minus 5 μm, is subjected to a heat treatment of 260° C. in a crystallizing dish in a ventilated oven. The powder is arranged in a crystallizing dish so that the thickness of the powder bed is between 1 and 1.5 cm.

After treatment, the powders were sieved on a 250 μm vibrating sieve in order to deagglomerate them.

The Dv50 referred to here is the median diameter by volume, which corresponds to the value of the particle size which divides the population of particles examined exactly into two. The Dv50 is measured according to the standard ISO 9276 -parts 1 to 6. In the present description, a Malvern particle sizer, Mastersizer 2000, is used and the measurement is carried out by the liquid route by laser diffraction on the powder.

The results are given in table 1 for residence times varying from 15 minutes to 25 minutes.

TABLE 1

| | | Kepstan 6003PL | | |
|---|---|---|---|---|
| | | | 15 min at | 25 min at |
| | | untreated | 260° C. | 260° C. |
| Flowability, | Time (s) | 48 | 35 | 17 |
| 17 mm funnel | Number of blows | multi | multi | 10 |

It is found that the flowability is improved from 15 min of heat treatment (flow in 35 s versus 48 s). A heat treatment of 25 min very significantly improves the flowability of the powder.

The term multi is employed when tapping on the funnel is continuous.

1. A process for the treatment of a powder comprising PEKK to obtain a treated powder, wherein the treated powder has a measured flowability exhibiting a passage time in a 17 mm funnel of less than 40 s, limit included, said flowability being measured in the following way:
a glass funnel with an orifice of 17 mm is filled with the treated powder up to 5 mm from the edge and the orifice of the bottom is blocked with a finger,
the flow time of the treated powder is measured with a stopwatch,
if flow does not take place, the funnel is tapped using a spatula, wherein the operation is repeated, if required,
the flow time and the number of tapped blows using the spatula are recorded, the process comprising the following stages:
arranging the powder comprising PEKK in a ventilated chamber or any other heating system;
heating the powder comprising PEKK at a temperature of between T−10° C. and T+10° C., where T=3.75*A+37.5, expressed in ° C., A representing the percentage by weight of terephthalic unit with respect to the sum of the terephthalic and isophthalic units of between 55% and 85%, and for a time strictly of less than 30 minutes.

2. The process as claimed in claim 1, wherein, in addition to the PEKK, the powder comprises a PEK, PEEKEK, PEEK or PEKEKK powder in proportions by weight such that the PEEK represents more than 50%.

3. The process as claimed in claim 1, wherein the powder additionally comprises a filler.

4. The process as claimed in claim 1, wherein the powder additionally comprises at least one additive.

5. The process as claimed in claim 1, wherein the ventilated chamber is a static oven.

6. The process as claimed in claim 1, wherein the ventilated chamber is a fluidized bed.

7. The process as claimed in claim 1, wherein the ventilated chamber is a tube in which hot air and the powder circulate countercurrentwise.

8. The process as claimed in claim 5, wherein the residence time is greater than 15 minutes but less than 30 minutes.

9. The process as claimed in claim 6, wherein the residence time is greater than 2 minutes but less than 30 minutes.
